(19) United States
(12) Patent Application Publication
(10) Pub. No.: US 2004/0204054 A1
(43) Pub. Date: Oct. 14, 2004

(54) Automatic voice and image inter-cellular phone security communication system

(76) Inventor: Hsiao-Chung Lee, Pan-Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/304,685

(22) Filed: Nov. 27, 2002

(51) Int. Cl. H04M 11/00; H04M 1/00; H04B 1/38

(52) U.S. Cl. 455/556.1; 455/557; 455/404.1

(57) ABSTRACT

An automatic voice and image inter-cellular phone security communication system is a combination of a sensor system, an inter-cellular phone system, and a CCD monitor system. When any moving object is detected by the sensor within its effective sensing zone, the sound and image of the moving object is captured by a built-in camera control device and transmitted to the receiving end cellular phone by automatic dialing according to a prescribed phone number stored in a telephone directory. In this way the user at the receiving end may take action against the emergency state immediately.

### BACKGROUND OF THE INVENTION

1. Field of the Invention

The present invention relates to an automatic voice and image inter-cellular phone security communication system, in particular, to a security communication system capable of transmitting voice and image of a suspectible object detected by a sensor installed in the remote surveillance zone from a sending end cellular phone to a receiving end cellular phone such that the user may be informed of what is happening in the scene so as to take a step against it.

2. Description of the Prior Art

In a particularly insecure area, only relying on the police patrol, or a security fence associated with a simple monitoring device plus a lighting system is insufficient to keep away ingress of burglars. The installation of an innovative remote control device associated with voice and image inter-cellular phone system which can not be easily violated by any skilled offender is of paramount importance.

In view of this, it is what the reason the inventor has endeavored for years by continuous research and experimentation attempting to find out a solution to this inherent problem, and finally has succeeded in realizing the present invention.

### SUMMARY OF THE INVENTION

It is a first object of the present invention to provide a security communication system with which the user can be aware of the condition of his/her house when being absent from the house.

It is a second object of the present invention to provide a security communication system with which the user can keep wholly under surveillance of his car that is parked anywhere. Should the car be stolen, H-internet can be used to help policemen trace it.

It is a third object of the present invention to provide a security communication system with which the owner of a factory can hold on to the operation of the factory during being absent.

It is a fourth object of the present invention to provide a security communication system which can be installed in an unattended warehouse (for example, in the night) so as to be remotely monitored.

It is a fifth object of the present invention to provide a security communication system with which the user can call up the present system by inputting a code number so as to inspect the situation at the scene, and the code number may be changed from the remote end so as to prevent being decoded by the intruder.

It is a sixth object of the present invention to provide a security communication system which can produce a sound alarm as soon as any moving object is detected so as to frighten the intruder, or the alarm can be activated by the user's cellular phone from the remote end.

It is a seventh object of the present invention to provide a security communication system with which on receiving the image information, the user may actuate the speaker of the output device to frighten the intruder with the receiving end cellular phone.

It is a eight object of the present invention to provide a security communication system with which the evening patrolman or the user may send an alarm sound or an image to the receiving end asking for help in an emergency case.

To achieve these and other objects mentioned above, the security communication system of the present invention is composed of a sensor, a cellular phone system (sending end), an infrared ray radiation device, a CCD monitor system, a built in or externally connected digital video system. In case the sensor (an infrared ray or equivalents) has detected an moving object, the present system is activated to capture its image along with its sound, and the captured data are sent to the receiving end cellular phone for the user to judge the situation and take a necessary step against it so as to clear out the possible loss. The present system can be constructed in various different outer looks and camouflaged in the domestic furniture and appliances.

### BRIEF DESCRIPTION OF THE DRAWINGS

The above objects and other advantages of the present invention will become more apparent by describing in detail the preferred embodiments of the present invention with reference to the attached drawings in which:

FIG. 1 is a block diagram illustrating the layout of the security communication system according to the present invention;

FIG. 2 is a schematic view showing how the security communication system of the present invention is equipped in a car;

FIGS. 3,4 are schematic views showing how the security communication system of the present invention is hidden and operated in an emergency light;

FIG. 5 is a schematic view showing how the security communication system of the present invention is camouflaged in a desk lamp; and

FIG. 6(A), 6(B) are schematic view showing how the security communication system of the present invention is made into a portable remote control unit.

### DETAILED DESCRIPTION OF THE PREFERRED EMBODIMENT

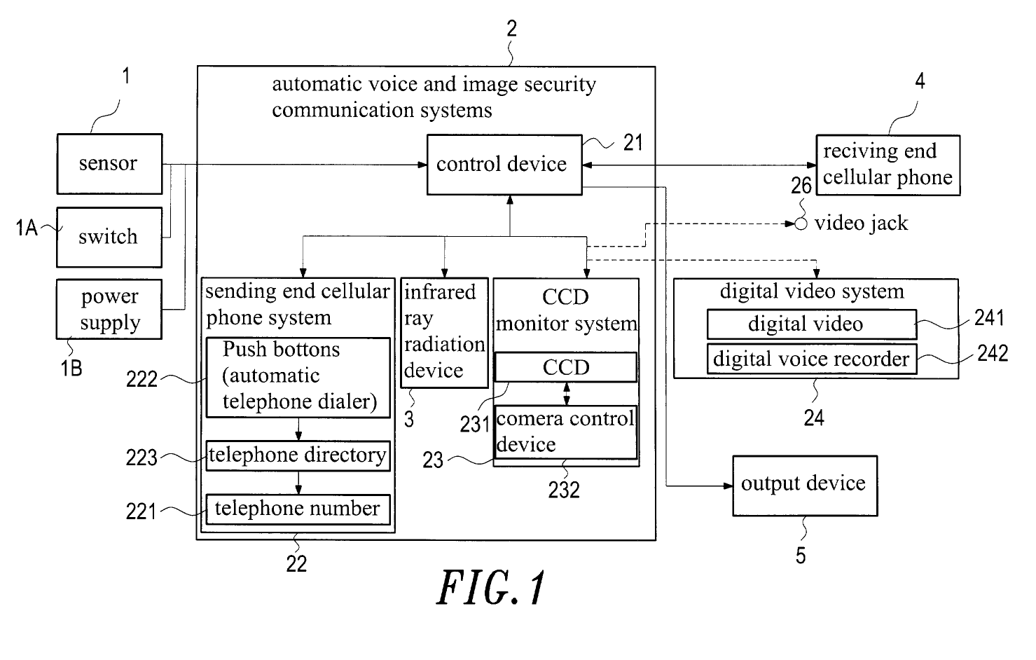

Referring to FIG. 1, it shows that the security communication system of the present invention is essentially composed of a sensor 1; a switch 1 A for switching sub-system of the present security communication system; a power supply 1B; a radio remote controller 1C for remote controlling the switch 1A, a control device 21; a sending end cellular phone system 22 including a group of individual phone numbers 221; push buttons for prestoring number for automatic phone dialer 222; and a telephone directory 223; an infrared ray radiation device 3; a CCD monitor system 23 including CCD 231 and a camera control device 232; a digital video system 24 including a digital video 241 and a digital voice recorder 242; a receiving end cellular phone 4; an output device 5; and an external video jack 26.

Incidentally, the function of this system will be illustrated as follows:

The sensor 1 which may be an infrared sensor 11, a microwave sensor 12, or an infrared temperature sensor 13 is used to detect any suspectible object. As soon as the sensor 1 has detected any moving object or objects, the control device 21 activates the sending end cellular phone system 22, CCD monitor system 23, and the digital video system 24 simultaneously. An image picture is captured by the camera control device 232 in CCD monitor system 23 and transmitted to the receiving end image receivable cellular phone 4 by automatic dialing according to phone number prestored in the telephone directory 223 by push buttons provided on the automatic telephone dialer 222. The camera control device 232 can continuously transmit image pictures with sound to the receiving end cellular phone 4 from the sending end cellular phone system 22 in a predetermined time duration (for example, 1 minute) so that the user may judge what is the situation happening at the sending end according to the voice and image information provided as such. On the other hand, the digital video system 24 activated by the control device 21 can operate to store the pictures with its digital video 241 and digital voice recorder 242, or a continuous long time recording can be carried out by plugging a video to the external video jack 26. After receiving the aforesaid data transmitted from the sending end, the user is also able to call back to the sending end with the receiving end cellular phone 4 using an code number, if necessary, to ask the control unit 21 stopping the operation of recording or data transmission.

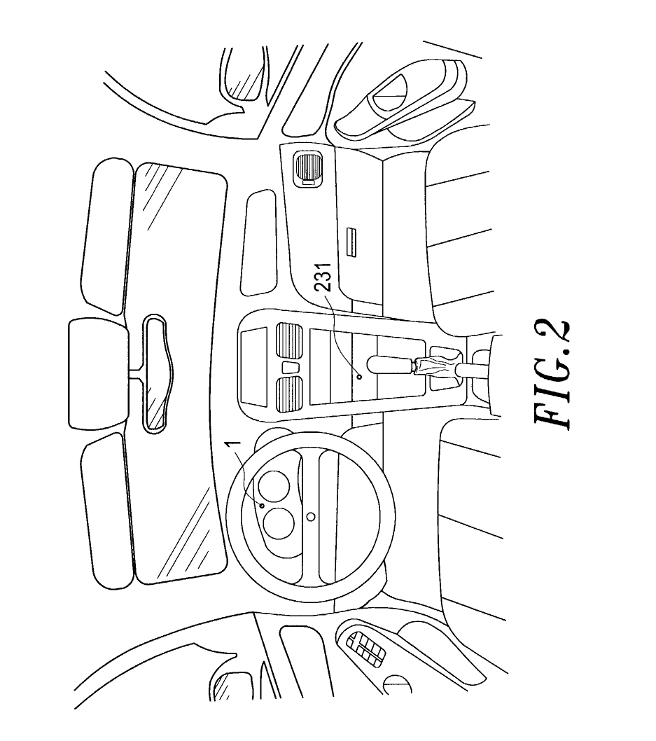

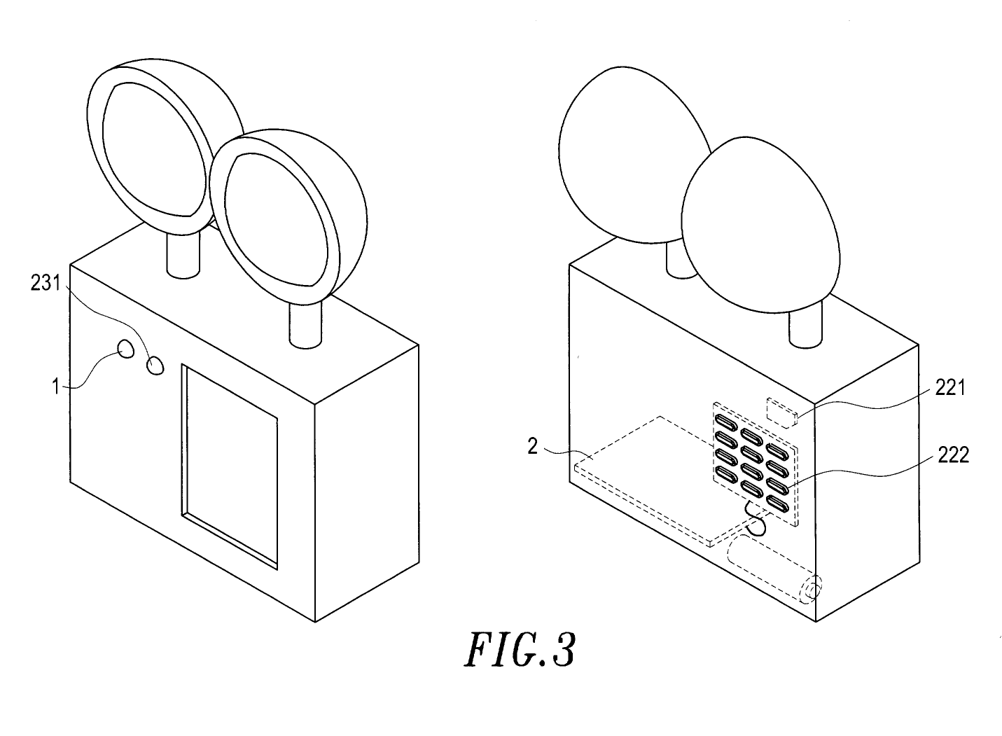

FIG. 2 is a schematic view showing that the security communication system is equipped underneath the dash board (or any other place) in a car. Here, only CCD monitor system 23 and the sensor 1 (infrared sensor 11, or microwave sensor 12) are emerged out of the dash board so as to conceal most part of the equipment from the intruder's eyes. As soon as a moving object or objects is detected by the sensor 1, its voice and image is transmitted to the receiving end cellular phone 4 by a radio automatic dialer 22 (i.e. the sending end cellular phone system) so that the user is informed what is happening to his/her car and takes a step against it.

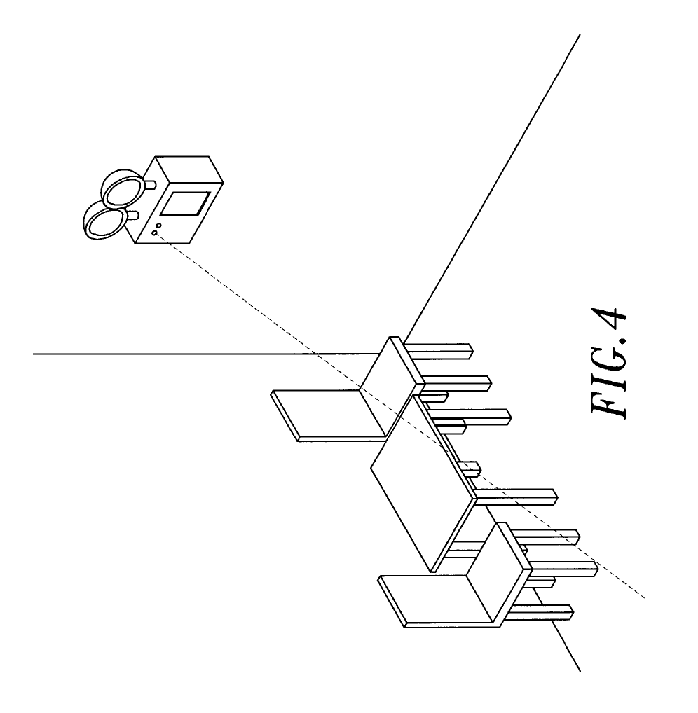

FIGS. 3 and 4 are schematic views showing how the security communication system is hidden and operated in an emergency light. As described above, any moving object is detected by the sensor 1 (infrared sensor 11, microwave sensor 12, or infrared thermal sensor 13), the control device 21 activates its radio automatic dialer 22, CCD monitor system 23, and the digital video system 24 so as to instruct the camera control device 232 in the CCD monitor system 23 to capture an image picture which is transmitted to the receiving end cellular phone 4 according to the phone number 221 prestored in the telephone directory 223. Thus the user may judge what is the situation happening in the scene. The receiving end cellular phone may be portable with the user to call up the sending end cellular phone system 22 asking for information. The control system 21 takes responsibility for surveillance of surrounding according to the instruction from the user. If the present system is to be installed at the place where no utility power can be supplied, an battery unit is an alternative replacement power source. In this case if no object is detected, the control unit 21 sets the system at a stand by state so as to save consumption of power supplying to the sensor 1.

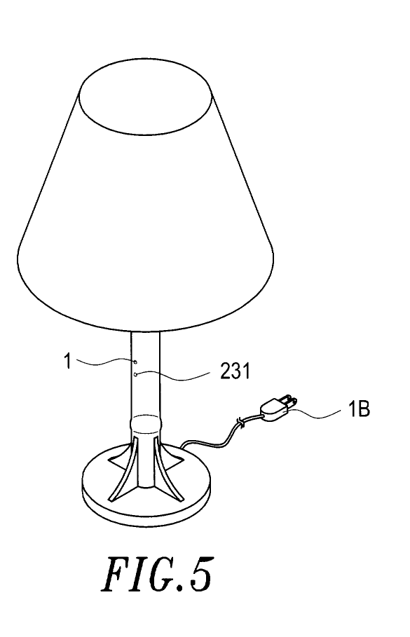

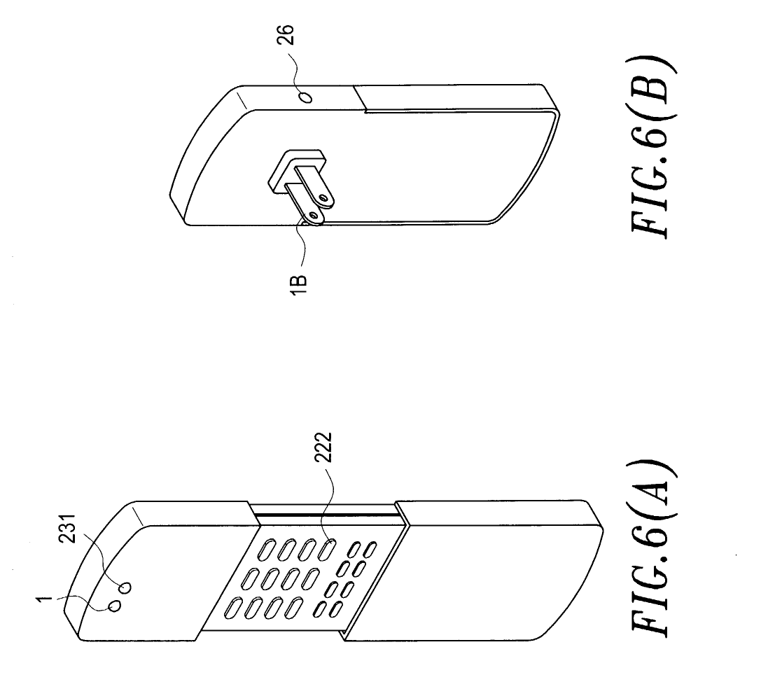

FIG. 5 shows how the security communication system is camouflaged in a stand lamp, and FIGS. 6(A) and 6(B) show how the security communication system is made into a portable remote control unit. With this structure, the installation of present system is difficult to be discovered by any skillful intruder.

From the above description of several examples, it will be understood that the automatic voice and image inter-cellular phone security communication system of the present invention is capable of transmitting voice and image of a suspectible moving object or objects detected by a sensor installed in the remote surveillance area from a sending end cellular phone system to a receiving end cellular phone such that the user may be informed of what is happening in the scene so as to take a step against it. The noteworthy features of the present security communication system are:

1. Capable of responsing to the situation at the monitoring zone instantaneously without particular selection for installation place. It can be installed in a residential house, factory, warehouse or in a vehicle to serve equally satisfactorily.

2. It can monitor in a dusk equally well as in the daylight.

3. It is characterized in having the ability of inter-cellular phone communication for voice and image information.

4. It can be formed into various random camouflaged figures and is difficult to be discovered.

5. It includes a digital video system which is usable to record the voice and image for filing.

Although the invention has been described in terms of preferred embodiments, it is apparent that numerous variations and modifications may be made without departing from the true spirit and scope thereof, as set forth in the following claims.

What is claimed is:

1. Automatic voice and image inter-cellular phone security communication system comprising:
a switch for ON/OFF control switching of sub-system included in the communication system of the present invention;
a power supply source selective from the utility power supply, a vehicle power supply, or a battery unit for supplying power to the present system;
a sensor for detecting a moving object or objects;
a voice and image receivable cellular phone for receiving voice and image information at the receiving end;
a CCD monitor system to be activated to capture an image picture of said moving object (objects) detected by said sensor;
an automatic radio telephone dialer to be activated to transmit said captured image picture to said receiving end cellular phone according to a prestored phone number in a telephone directory;
a digital video system composed of a digital video and a digital voice recorder;
an infrared ray radiation device disposed around the protected zone for providing the necessary lighting for a camera control device included in said CCD system;
a control device for activating said CCD monitor system and said automatic telephone dialer, also actuates said digital video system to record the situation at the scene for filing;
an output device for frightening the intruder with an alarm bell, a speaker, or the way of mutual talking.

2. The security communication system of claim 1, wherein said sensor is an infrared sensor.

3. The security communication system of claim 1, wherein said sensor is a microwave sensor.

4. The security communication system of claim 1, wherein said sensor is an infrared temperature sensor.

5. The security communication system of claim 1, wherein said digital video system is composed of a digital video and a digital voice recorder.

6. The security communication system of claim 1, wherein said digital video system is either a built-in type, or an externally connected type to be plugged into a video jack, and said digital video system can be omitted according to the user's decision.

7. The security communication system of claim 1, wherein said receiving end cellular phone shall be receivable of image pictures.

8. The security communication system of claim 1, wherein said output device is applicable for mutual conversation.

9. The security communication system of claim 1, wherein said output device includes functions of a loud speaker, or an alarm bell.

10. The security communication system of claim 1, wherein said system further includes a radio remote control switch.
